(19) United States
(12) Patent Application Publication
(10) Pub. No.: US 2019/0080201 A1
(43) Pub. Date: Mar. 14, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomohiko Kuroki, Yokohama-shi (JP)

(21) Appl. No.: 16/117,574

(22) Filed: Aug. 30, 2018

(30) Foreign Application Priority Data
Sep. 8, 2017 (JP) 2017-173374
May 31, 2018 (JP) 2018-104554

(51) Int. Cl. G06K 9/62; G06T 3/40; G06T 7/246; G06K 9/00

(52) U.S. Cl. CPC G06K 9/6202; G06K 9/00369; G06T 7/248; G06T 3/4038

(57) ABSTRACT

An image processing apparatus includes an image generation unit configured to generate a plurality of images in different sizes by reducing an input image, and a specific object detection unit configured to detect a specific object by executing matching processing of a template image with respect to a part of the plurality of images, or by executing matching processing of a template image with respect to the plurality of images in different orders according to the input image.

### BACKGROUND

### Field

The present invention relates to an image processing apparatus, an image processing method, and a storage medium.

### Description of the Related Art

A monitoring camera executes image analysis of an input image and determines presence or absence of humans to detect intruders or to count a number of people without performing 24-hour monitoring by an observer. When a specific object such as a human body is detected from an input image, the monitoring camera executes detection through pattern matching processing. In the pattern matching processing, the monitoring camera generates an image pyramid as a group of reduced images acquired by recursively reducing the input images, and executes matching processing of the reduced images (i.e., layers) with a template image to detect human bodies in different sizes.

Japanese Patent No. 5924991 discusses a technique of switching a priority level of layers of reduced images used for pattern matching based on the previous detection results. Japanese Patent No. 5795916 discusses a technique of improving processing speed by associating a layer type with an area.

However, if pattern matching processing is executed on reduced images of the entire layers, processing load will be increased. Therefore, in a case where human body detection processing is executed in real time, human body detection processing that is being executed on the current image has to be discontinued halfway if a next image is input thereto in the course of processing, in order to execute human body detection processing on the next image.

According to the technique discussed in Japanese Patent No. 5924991, detection accuracy may rather be lowered under the condition where an imaging environment of the image is changed significantly. According to the technique discussed in Japanese Patent No. 5795916, processing speed cannot be improved at a location having a depth, where small and large human bodies (i.e., small and large images of human bodies) exist in a mixed state.

### SUMMARY OF THE INVENTION

According to an aspect of the present invention, an image processing apparatus includes an image generation unit configured to generate a plurality of images in different sizes by reducing an input image, and a specific object detection unit configured to detect a specific object by executing matching processing of a template image with respect to a part of the plurality of images, or by executing matching processing of a template image with respect to the plurality of images in different order according to the input image.

Further features of the present invention will become apparent from the following description of exemplary embodiments with reference to the attached drawings.

### BRIEF DESCRIPTION OF THE DRAWINGS

FIG. 1 is a block diagram illustrating a configuration of a human body detection system.

FIGS. 2A, 2B, and 2C are diagrams illustrating layers of reduced images generated by a human body detection apparatus.

FIG. 3 is a diagram illustrating moving body detection executed by the human body detection apparatus.

FIG. 4 is a diagram illustrating detection scan processing executed by the human body detection apparatus.

FIG. 5 is a flowchart illustrating an image processing method.

FIG. 6 is a block diagram illustrating a configuration of a human body detection system.

FIG. 7 is a diagram illustrating vanishing point detection executed by the human body detection apparatus.

FIGS. 8A and 8B are diagrams illustrating layers of reduced images generated by the human body detection apparatus.

FIG. 9 is a flowchart illustrating an image processing method.

FIG. 10 is a block diagram illustrating a configuration of a human body detection system.

FIG. 11 is a flowchart illustrating an image processing method.

FIG. 12 is a block diagram illustrating a configuration of the human body detection system.

FIGS. 13A, 13B, and 13C are diagrams illustrating layers of reduced images generated by the human body detection apparatus.

FIG. 14 is a flowchart illustrating an image processing method.

### DESCRIPTION OF THE EMBODIMENTS

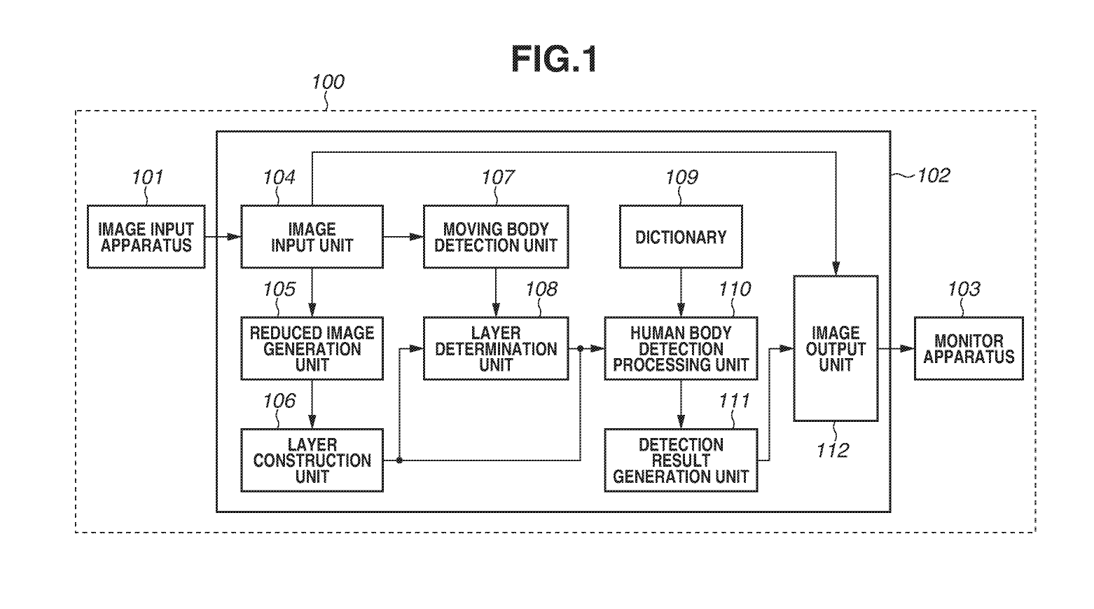

FIG. 1 is a block diagram illustrating a configuration example of a human body detection system 100 according to a first exemplary embodiment of the present disclosure. The human body detection system 100 is a specific object detection system for detecting a human body (specific object) in an image from input image information to display the detected human body. The specific object is not limited to a human body. Hereinafter, detection of a human body as a specific object will be described as an example. The human body detection system 100 includes an image input apparatus 101, a human body detection apparatus 102, and a monitor apparatus 103. The human body detection apparatus 102 and the monitor apparatus 103 are connected to each other via a video interface. The image input apparatus 101 is an apparatus configured of a camera and the like, which captures a surrounding image to generate a captured image. The image input apparatus 101 outputs the captured image information to the human body detection apparatus 102.

The human body detection apparatus 102 is an image processing apparatus. When image information is input from the image input apparatus 101, the human body detection apparatus 102 executes detection processing of a human body included in the image and outputs a detection result and a processed image to the monitor apparatus 103 via an image output unit 112. The human body detection apparatus 102 includes an image input unit 104, a reduced image generation unit 105, a layer construction unit 106, a moving body detection unit 107, a layer determination unit 108, a dictionary 109, a human body detection processing unit 110, a detection result generation unit 111, and an image output unit 112.

The image input unit 104 receives image information captured by the image input apparatus 101, and outputs the image information to the reduced image generation unit 105, the moving image detection unit 107, and the image output unit 112. The reduced image generation unit 105 recursively reduces the image input from the image input unit 104 to generate a plurality of reduced images having different sizes, and outputs the original image and the reduced images to the layer construction unit 106. The layer construction unit 106 generates an image pyramid from the original image and the reduced images input from the reduced image generation unit 105, and constructs a layer to which each of the images is allocated as a processing layer.

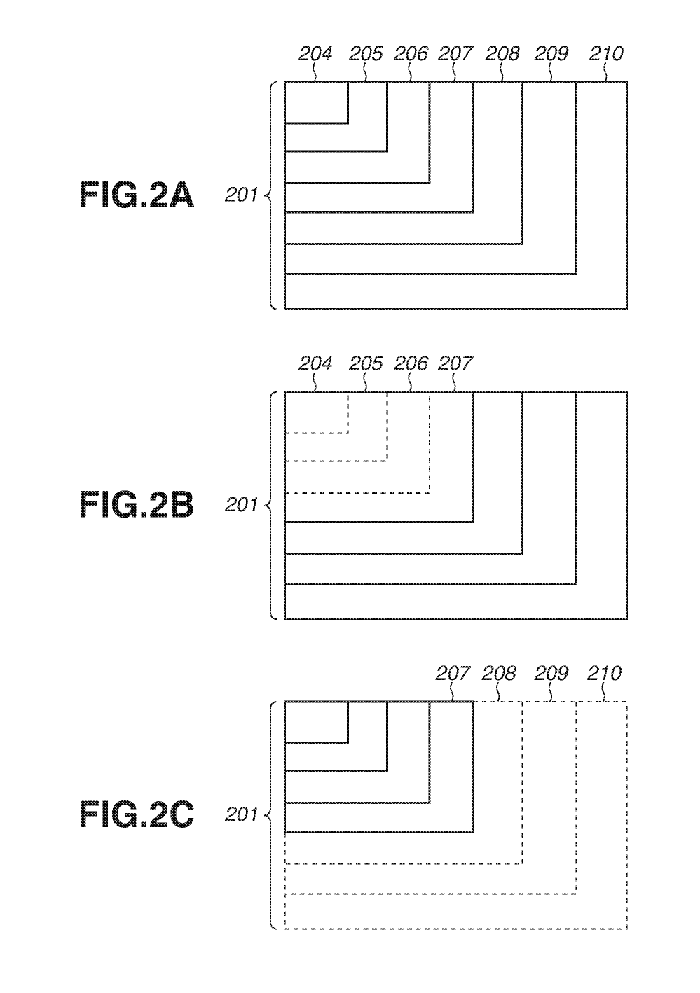

Herein, a layer structure 201 of the image pyramid will be described with reference to FIG. 2A. The reduced image generation unit 105 generates a plurality of reduced images 204 to 209 having different sizes by recursively reducing an image 210 input from the image input unit 104. The layer construction unit 106 constructs the layer structure 201 of the image pyramid from the input original image 210 and the reduced images 204 to 209. The layer construction unit 106 sets the input original image 210 as a bottommost layer, and stacks the reduced image 209 generated by reducing the original image 210 and the reduced image 208 generated by reducing the reduced image 209 one on top of another. Similarly, the layer construction unit 106 respectively stacks the reduced image 207 generated by reducing the reduced image 208, the reduced image 206 generated by reducing the reduced image 207, the reduced image 205 generated by reducing the reduced image 206, and the reduced image 204 generated by reducing the reduced image 205 one on top of another. The layer construction unit 106 generates an image pyramid in which the reduced images 204 to 209 are stacked, and allocates layers 0, 1, 2, . . . , and 6 to the seven images 204 to 210 in the order starting from the reduced image 204 stacked on top of the image pyramid to the original image 210 to construct the layer structure 201. Basically, unless otherwise specified, the layer construction unit 106 executes processing of the layer structure 201 of the image pyramid in the order starting from the layer 0 as a starting layer to the layer 6 as an ending layer. The layer construction unit 106 outputs layer structure information of the layer structure 201 to the layer determination unit 108 and then to the human body detection processing unit 110.

The moving body detection unit 107 detects a moving body included in the image input from the image input unit 104. As a moving body detection method, the moving body detection unit 107 uses an inter-frame difference method in which a moving image included in the image is detected from a difference between images input previous time and next time. Because the inter-frame difference method is a known technique, details thereof will not be described. The moving body detection unit 107 outputs rectangle information of a detected moving body to the layer determination unit 108.

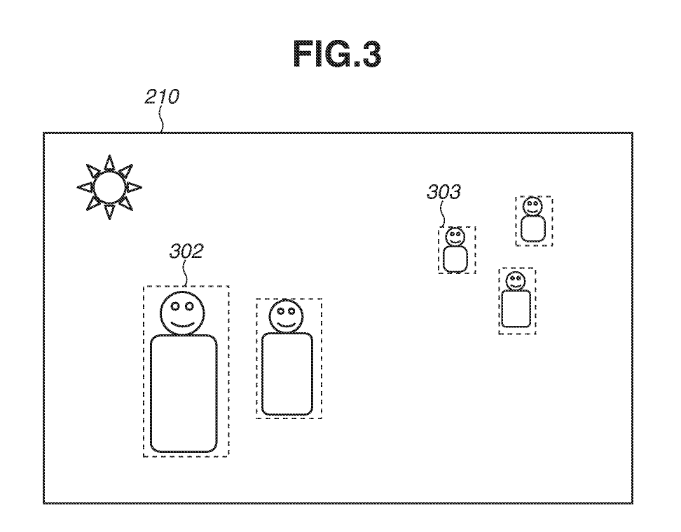

The layer determination unit 108 determines a layer detection starting position and a layer detection ending position based on the layer structure information input from the layer construction unit 106 and the rectangle information of each moving body included in the image input from the moving body detection unit 107. Here, processing of changing a layer detection starting position and a layer detection ending position will be described with reference to FIGS. 2B, 2C, and 3.

FIG. 3 is a diagram illustrating a detection result of moving bodies by the moving body detection unit 107. The moving body detection unit 107 detects moving bodies in the input image 210 and outputs rectangle information of the detected moving bodies. The layer determination unit 108 receives the rectangle information of the respective moving bodies in the input image 210, specifies a rectangle 302 including a largest moving body and a rectangle 303 including a smallest moving body from the input rectangle information, and acquires respective sizes of the rectangles 302 and 303. The layer determination unit 108 determines a layer detection starting position according to the size of the rectangle 302 including the largest moving body, and determines a layer detection ending position according to the size of the rectangle 303 including the smallest moving body.

The layer determination unit 108 determines a layer detection starting position according to the size of the rectangle 302 if the size of the rectangle 302 including the largest moving body is smaller than a maximum size of a detectable human body. For example, as illustrated in the layer structure 201 in FIG. 2B, the layer determination unit 108 determines the layer 3 of the reduced image 207 as the layer detection starting position according to the size of the rectangle 302 including the largest moving body. With this determination, the human body detection processing unit 110 skips the processing of the layers of the reduced images 204, 205, and 206, and starts executing the processing from the layer of the reduced image 207 which is suitable for detecting a human body of a size corresponding to the size of the rectangle 302 including the moving body.

Further, the layer determination unit 108 determines a layer detection ending position according to the size of the rectangle 303 if a size of the rectangle 303 including the smallest moving body is greater than a minimum size of a detectable human body. For example, as illustrated in the layer structure 201 in FIG. 2C, the layer determination unit 108 determines the layer 3 of the reduced image 207 as a layer detection ending position according to the size of the rectangle 303 including the smallest moving body. With this determination, the human body detection processing unit 110 executes the processing up to the layer of the reduced image 207 which is appropriate for detecting a human body of a size corresponding to the size of the rectangle 303 including the moving body, and skips the processing of the layers of the reduced images 208, 209, and the original image 210.

The layer determination unit 108 outputs the determined layer detection starting position and the layer detection ending position to the human body detection processing unit 110. The dictionary 109 stores a large number of template images used for human body detection as a dictionary, and outputs a template image used for human body detection to the human body detection processing unit 110. The human body detection processing unit 110 uses the layer structure information input from the layer construction unit 106, information about the layer detection starting position and the layer detection ending position input from the layer determination unit 108, and the template image for human body detection input from the dictionary 109 to execute human body detection processing. The human body detection processing unit 110 serving as a specific object detection unit executes matching processing of a template image with respect to all or a part of the images 204 to 210 of respective layers to detect a human body (specific object). The human body detection processing unit 110 sequentially executes human body detection processing from an image of the layer detection starting position and ends the processing at an image of the layer detection ending position.

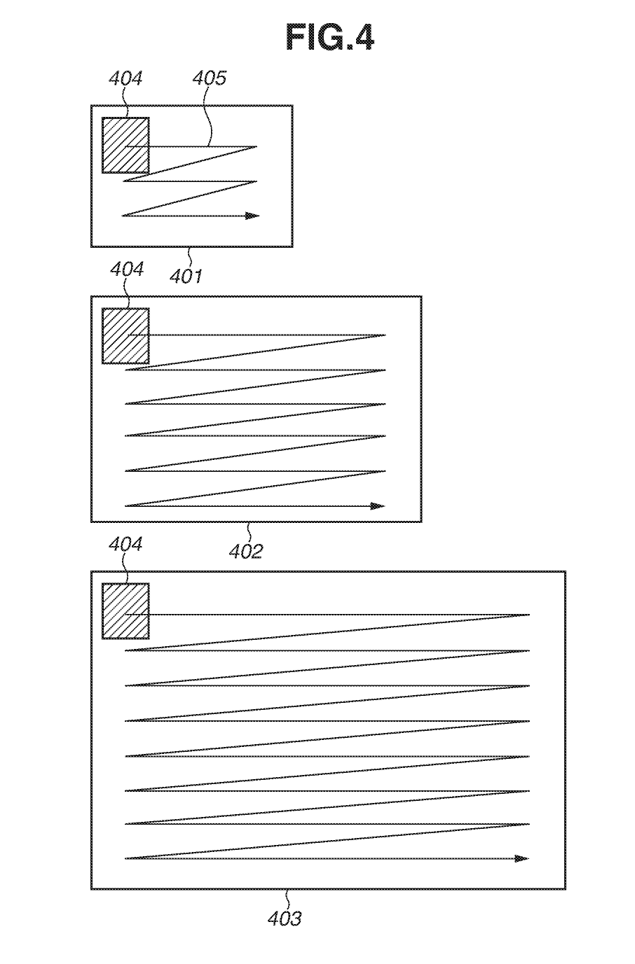

FIG. 4 is a diagram illustrating processing of detecting a human body executed by the human body detection processing unit 110. The human body detection processing unit 110 executes raster scanning of images 401 to 403 of respective layers with a template image 404 for human body detection in scanning order 405 to detect human bodies in the images 401 to 403. The images 401 to 403 correspond to all or a part of the plurality of images 204 to 210 in different sizes illustrated in FIG. 2A. The human body detection processing unit 110 executes matching processing of the template image 404 with respect to the plurality of images 401 to 403 to detect human bodies. As described above, the human body detection processing unit 110 can detect a larger human body from the smaller image 401 and a smaller human body from the larger image 403 by executing human body detection processing with respect to the images 401 to 403 of respective layers. In order to execute human body detection processing in real time, the human body detection processing unit 110 discontinues human body detection processing of a current image and starts human body detection processing of a next image if the next image is input thereto in the middle of human body detection processing. The human body detection processing 110 executes matching processing of the template image 404 on a part of the images from among the plurality of images 204 to 210 according to the information about the layer detection starting position and the layer detection ending position to detect a human body. In this way, time taken for human body detection is reduced, and thus it is possible to prevent discontinuation of human body detection processing. The human body detection processing unit 110 outputs the detected human body information to the detection result generation unit 111.

The detection result generation unit 111 generates rectangle information of the human body based on the human body information input from the human body detection processing unit 110. The detection result generation unit 111 outputs the generated rectangle information to the image output unit 112. The image output unit 112 superimposes the rectangle information of the human body input from the detection result generation unit 111 on the image input from the image input unit 104, and outputs the image with the superimposed rectangle information of the human body to the monitor apparatus 103. The monitor apparatus 103 displays the image output from the image output unit 112 of the human body detection apparatus 102.

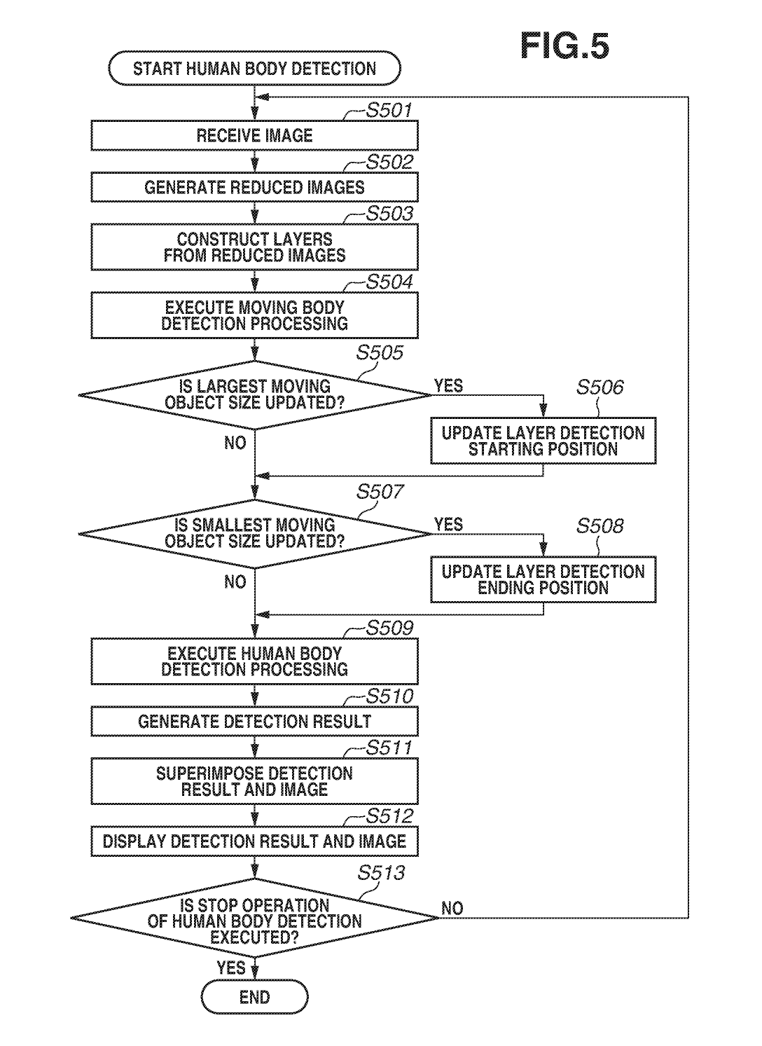

FIG. 5 is a flowchart illustrating an image processing method executed by the human body detection system 100 according to the first exemplary embodiment. The human body detection system 100 is activated through a user operation to start human body detection processing. First, in step S501, the image input unit 104 receives the image 210 from the image input apparatus 101. In step S502, the reduced image generation unit 105 recursively reduces the image 210 input from the image input unit 104 to generate the reduced images 204 to 209. In step S503, the layer construction unit 106 constructs the layer structure 201 from the input image 210 and the reduced images 204 to 209. In step S504, the moving body detection unit 107 executes processing of detecting moving bodies from the image 210 input from the image input unit 104, and acquires a size of the rectangle 303 including the smallest moving body and a size of the rectangle 302 including the largest moving body.

In step S505, the layer determination unit 108 determines whether the size of the rectangle 302 including the largest moving body input from the moving body detection unit 107 is updated. A default value of the rectangle size including the largest moving body is a maximum detectable rectangle size. If the layer determination unit 108 determines that the size of the rectangle 302 including the largest moving body is updated (YES in step S505), the processing proceeds to step S506. If the layer determination unit 108 determines that the size of the rectangle 302 including the largest moving body is not updated (NO in step S505), the processing proceeds to step S507. In step S506, the layer determination unit 108 determines a layer detection starting position from the size of the rectangle 302 including the largest moving body in the image 210 and updates the layer detection starting position. Then, the processing proceeds to step S507.

In step S507, the layer determination unit 108 determines whether the size of the rectangle 303 including the smallest moving body input from the moving body detection unit 107 is updated. A default value of the rectangle size including the smallest moving body is a minimum detectable rectangle size. If the layer determination unit 108 determines that the size of the rectangle 303 including the smallest moving body is updated (YES in step S507), the processing proceeds to step S508. If the layer determination unit 108 determines that the size of the rectangle 303 including the smallest moving body is not updated (NO in step S507), the processing proceeds to step S509. In step S508, the layer determination unit 108 determines a layer detection ending position from the size of the rectangle 303 including the smallest moving body in the image 210 and updates the layer detection ending position. Then, the processing proceeds to step S509.

In step S509, the human body detection processing unit 110 executes human body detection processing of each of the layers according to the layer detection starting position and the layer detection ending position determined by the layer determination unit 108. In step S510, the detection result generation unit 111 generates rectangle information of the human body based on the human body information input from the human body detection processing unit 110. In step S511, the image output unit 112 superimposes the rectangle information of the human body input from the detection result generation unit 111 on the image 210 input from the image input unit 104 and outputs the image with the superimposed rectangle information of the human body to the monitor apparatus 103. In step S512, the monitor apparatus 103 displays the image input from the image output unit 112.

In step S513, an ON/OFF switch of human body detection processing is operated through user operation, so that the human body detection system 100 determines whether a stop operation of human body detection processing is executed. If the human body detection system 100 determines that a stop operation is not executed (NO in step S513), the processing returns to step S501. If the human body detection system 100 determines that a stop operation is executed (YES in step S513), the human body detection processing is ended.

In addition, the moving body detection unit 107 may detect a current congestion degree based on the detected moving bodies. In this case, if the congestion degree is a threshold value or more, the human body detection processing unit 110 determines that the monitoring area is congested, and executes matching processing of the template image with respect to all of the images 204 to 210. Further, if the congestion degree is less than the threshold value, the human body detection processing unit 110 determines that the monitoring area is not congested, and executes matching processing of the template image with respect to a part of the images 204 to 210 as described above according to the layer detection starting position and the layer detection ending position.

As described above, the human body detection system 100 changes the layer detection starting position and the layer detection ending position according to the sizes of the rectangle 302 including the largest moving body and rectangle 303 including the smallest moving body. The human body detection processing unit 110 executes matching processing of the template image with respect to a part of the images 204 to 210 according to the sizes of the rectangle 302 including the largest moving body and rectangle 303 including the smallest moving body in the image 210 to detect human bodies. With this configuration, the human body detection system 100 can execute highly precise human body detection with low load even under the condition where an imaging environment of the image is changed significantly.

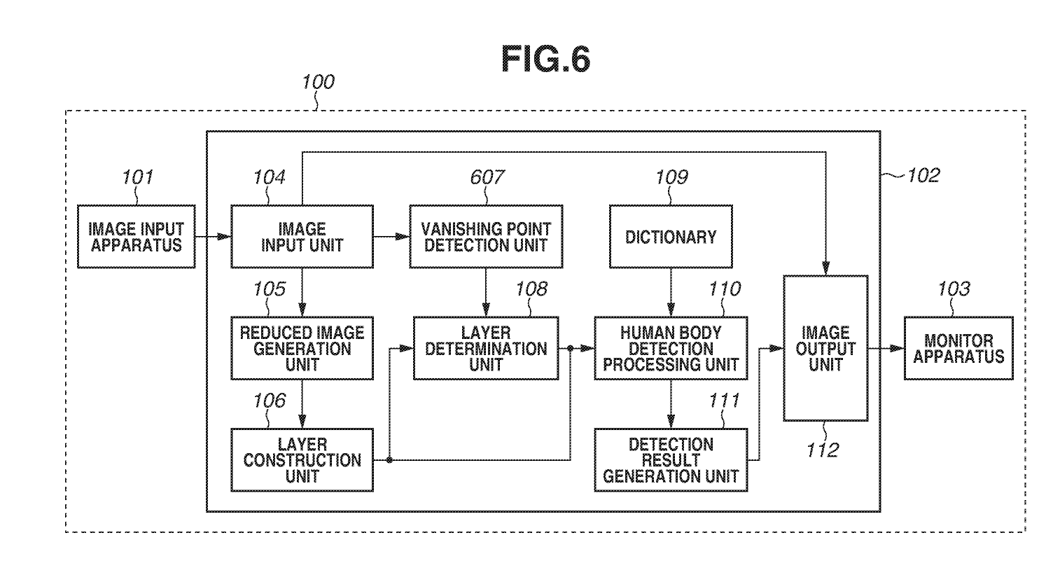

FIG. 6 is a block diagram illustrating a configuration example of a human body detection system 100 according to a second exemplary embodiment of the present disclosure. The human body detection system 100 illustrated in FIG. 6 includes a vanishing point detection unit 607 instead of the moving body detection unit 107 included in the human body detection system 100 illustrated in FIG. 1. The vanishing point detection unit 607 is disposed within a human body detection apparatus 102, and detects a vanishing point in a perspective image input from an image input unit 104. Hereinafter, part of the present exemplary embodiment different from the part of the first exemplary embodiment will be described.

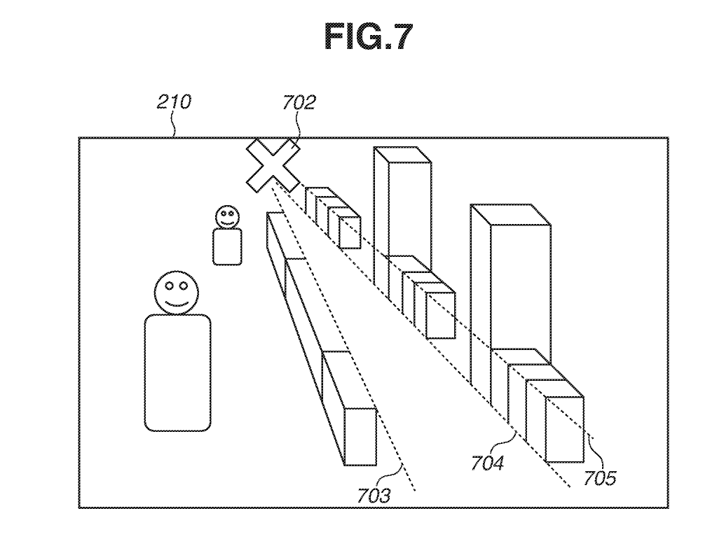

FIG. 7 is a diagram illustrating a detection method of a vanishing point executed by the vanishing point detection unit 607. The vanishing point detection unit 607 receives an image 210 from an image input unit 104, executes edge detection processing on the input image 210, and acquires straight lines 703, 704, and 705 on the image 210 through Hough transformation processing. Then, the vanishing point detection unit 607 detects a point at which three or more straight lines 703 to 705 intersect with each other in the image 210 as a vanishing point 702. Because the edge detection processing and the Hough transformation processing are known techniques, details of the descriptions thereof will be omitted. The vanishing point detection unit 607 outputs the detected vanishing point 702 to a layer detection unit 108.

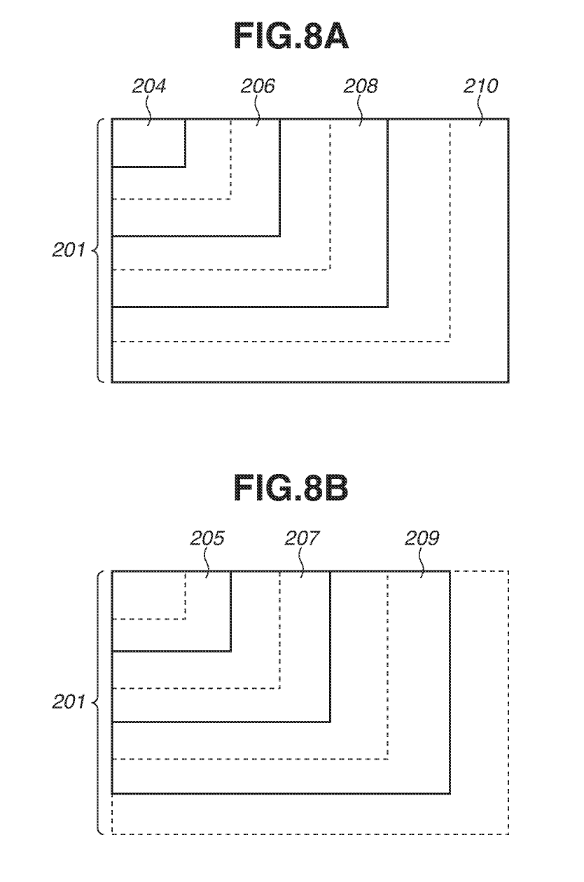

Based on a layer structure 201 input from a layer construction unit 106 and the vanishing point 702 input from the vanishing point detection unit 607, the layer determination unit 108 determines the order of layers on which human body detection processing is to be executed. If the vanishing point 702 exists in the image 210, there is a high possibility that small human bodies and large human bodies exist in the input image 210 in a mixed state. Therefore, if human body detection processing is executed sequentially, detection processing of small human bodies, which is to be executed at the last part of the processing order, may be discontinued. Thus, there is a case where detection failures frequently occur only in detection of small human bodies. Therefore, in order to detect small and large human bodies uniformly, the layer determination unit 108 determines that detection processing should be executed in the order of the images 204, 206, 208, and 210 of alternate layers as illustrated in the layer structure 201 in FIG. 8A. Then, as illustrated in the layer structure 201 in FIG. 8B, the layer determination unit 108 determines that detection processing should be executed in the order of the images 205, 207, and 209, which are skipped in the detection processing in FIG. 8A. In other words, the layer determination unit 108 determines that detection processing should be executed in the order of layers illustrated in FIG. 8A and the order of layers illustrated in FIG. 8B thereafter. If the vanishing point 702 does not exist in the image 210, the layer determination unit 108 determines that detection processing should be sequentially executed in the order from the image 204 of the layer for detecting large human bodies to the image 210 for detecting small human bodies. The layer determination unit 108 outputs the information about the determined detection processing order to the human body detection processing unit 110.

Although the vanishing point detection unit 607 is provided for detecting a scene in which small human bodies and large human bodies exist in a mixed state, it is not limited thereto. The moving body detection unit 107 described in the first exemplary embodiment may detect a scene in which small human bodies and large human bodies exist in a mixed state based on the sizes of respective moving bodies in the image 210.

The human body detection processing unit 110 executes human body detection processing by using the layer structure information input from the layer construction unit 106, the detection processing order information input from the layer determination unit 108, and a template image for human body detection input from the dictionary 109. The human body detection processing unit 110 executes human body detection processing similar to that of the first exemplary embodiment in the order of frames according to the detection processing order information. Configurations other than the above-described configurations are similar to the configurations described in the first exemplary embodiment.

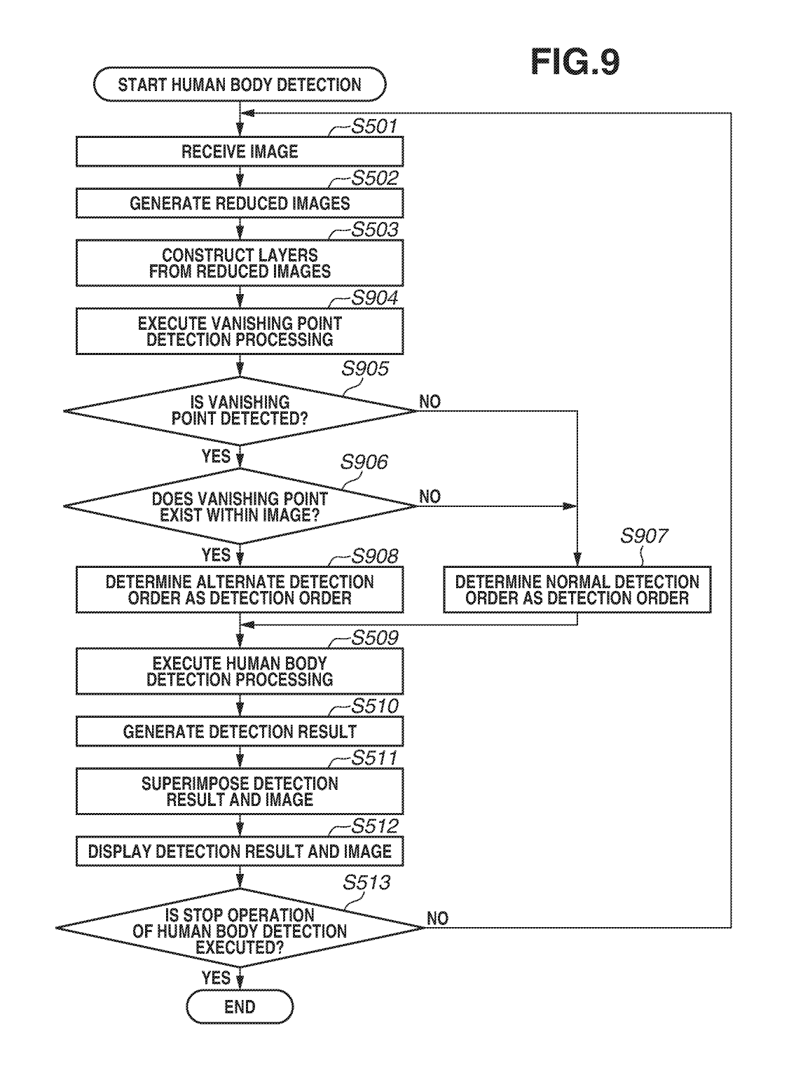

FIG. 9 is a flowchart illustrating an image processing method by the human body detection system 100 according to the present exemplary embodiment. The flowchart in FIG. 9 includes steps S904 to S908 in place of steps S504 to S508 of the flowchart illustrated in FIG. 5. Hereinafter, the present exemplary embodiment different from the first exemplary embodiment will be described.

First, in step S501, the image input unit 104 receives the image 210 from the image input apparatus 101. In step S502, the reduced image generation unit 105 recursively reduces the image 210 input from the image input unit 104 to generate the reduced images 204 to 209. In step S503, the layer construction unit 106 constructs the layer structure 201 from the input image 210 and the reduced images 204 to 209.

In step S904, the vanishing point detection unit 607 executes detection processing of the vanishing point 702 in the image 210 input from the image input unit 104. In step S905, the layer determination unit 108 determines whether the vanishing point detection unit 607 detects the vanishing point 702. If the layer determination unit 108 determines that the vanishing point detection unit 607 detects the vanishing point 702 (YES in step S905), the processing proceeds to step S906. If the layer determination unit 108 determines that the vanishing point detection unit 607 does not detect the vanishing point 702 (NO in step S905), the processing proceeds to step S907.

In step S906, the layer determination unit 108 determines whether the vanishing point 702 detected by the vanishing point detection unit 607 exists in the image 210. If the layer determination unit 108 determines that the vanishing point 702 exists in the image 210 (YES in step S906), the processing proceeds to step S908. If the layer determination unit 108 determines that the vanishing point 702 does not exist in the image 210 (NO in step S906), the processing proceeds to step S907.

In step S907, the layer determination unit 108 determines a normal detection processing order in which processing is executed in sequential order from a layer for detecting large human bodies to a layer for detecting small human bodies as the detection processing order. Then, the processing proceeds to step S509.

In step S908, the layer determination unit 108 determines detection processing order in which the layers are processed in the alternate order as illustrated in FIGS. 8A and 8B as the detection processing order. Then, the processing proceeds to step S509.

In step S509, the human body detection processing unit 110 executes human body detection processing of respective layers according to the layer detection processing order determined by the layer determination unit 108. In step S510, the detection result generation unit 111 generates rectangle information of the human body based on the human body information input from the human body detection processing unit 110. In step S511, the image output unit 112 superimposes the rectangle information of the human body input from the detection result generation unit 111 on the image 210 input from the image input unit 104, and outputs the image with the superimposed rectangle information of the human body to the monitor apparatus 103. In step S512, the monitor apparatus 103 displays the image input from the image output unit 112. In step S513, the human body detection system 100 executes the processing similar to that of the first exemplary embodiment.

As described above, the human body detection processing unit 110 executes matching processing of the template image with respect to the plurality of images 204 to 210 in different orders according to a detection result of the vanishing point 702 executed by the vanishing point detection unit 607. If the vanishing point 702 is not detected, the human body detection processing unit 110 executes matching processing of the template image with respect to the plurality of images 204 to 210 in the order according to the size of the image as described in step S907. Further, if the vanishing point 702 is detected, the human body detection processing unit 110 executes matching processing of the template image with respect to the plurality of images 204 to 210 in the order not according to the size of the image as described in step S908. In this way, even if the orientation of the image input apparatus 101 has been changed to cause a captured image to have a view angle at which small and large human bodies exist in the mixed manner, the human body detection system 100 can prevent variations in precision of human body detection, which may occur depending on sizes of human bodies.

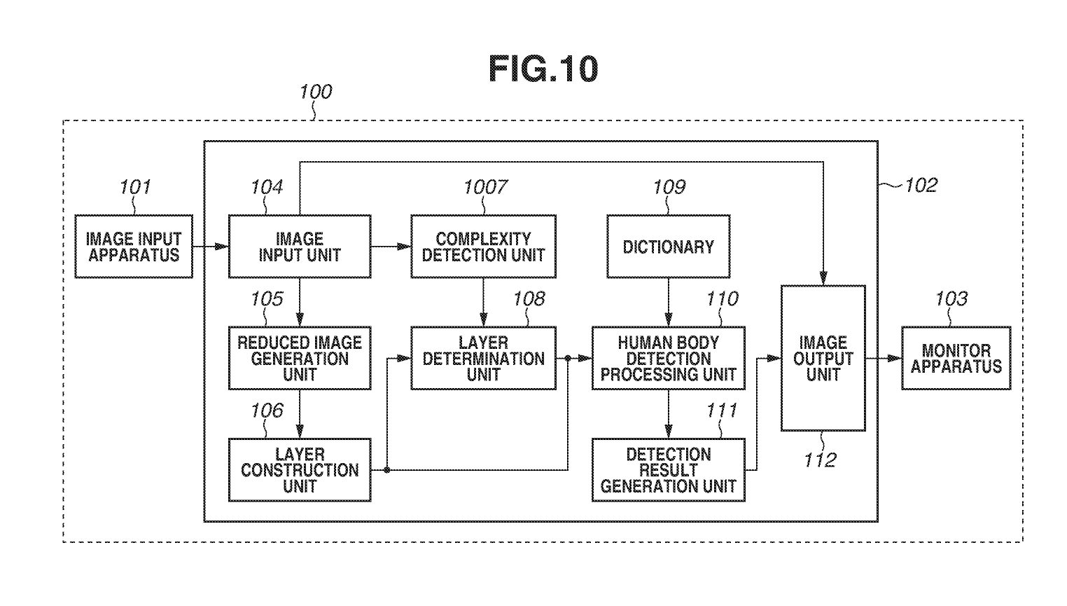

FIG. 10 is a block diagram illustrating a configuration example of a human body detection system 100 according to a third exemplary embodiment of the present disclosure. The human body detection system 100 in FIG. 10 includes a complexity detection unit 1007 instead of the moving body detection unit 107 included in the human body detection system 100 in FIG. 1. The complexity detection unit 1007 is arranged in a human body detection apparatus 102. Hereinafter, part of the present exemplary embodiment different from the first exemplary embodiment will be described.

The complexity detection unit 1007 executes edge detection processing on an image 210 input from an image input unit 104 to detect complexity of the entire image 210. Because the edge detection processing is a known technique, details thereof will not be described. The complexity detection unit 1007 outputs the complexity information of the entire image 210 to a layer determination unit 108.

Based on the layer structure information input from a layer construction unit 106 and the complexity information input from the complexity detection unit 1007, the layer determination unit 108 determines detection order of layers on which the detection processing is to be executed. If complexity of the entire image 210 is a predetermined threshold value or more, there is a high possibility that a large number of small human bodies exist. Therefore, the layer determination unit 108 determines that processing should be sequentially executed in the order from a layer of a large image for detecting small human bodies to a layer of a small image. Further, if complexity of the entire image 210 is less than the predetermined threshold value, there is a high possibility that a large number of large human bodies exist. Therefore, the layer determination unit 108 determines that processing should be sequentially executed in the order from a layer of a small reduced image for detecting large human bodies to a layer of a large image. The layer determination unit 108 outputs information about the determined detection order to the human body detection processing unit 110.

The human body detection processing unit 110 uses the layer structure information input from the layer construction unit 106, the detection order information input from the layer determination unit 108, and the template image for human body detection input from the dictionary 109 to execute human body detection processing. The human body detection processing unit 110 executes human body detection processing on the respective layers in the detection order of layers indicated by the detection order information. Configurations other than the above-described configuration are similar to the configurations described in the first exemplary embodiment.

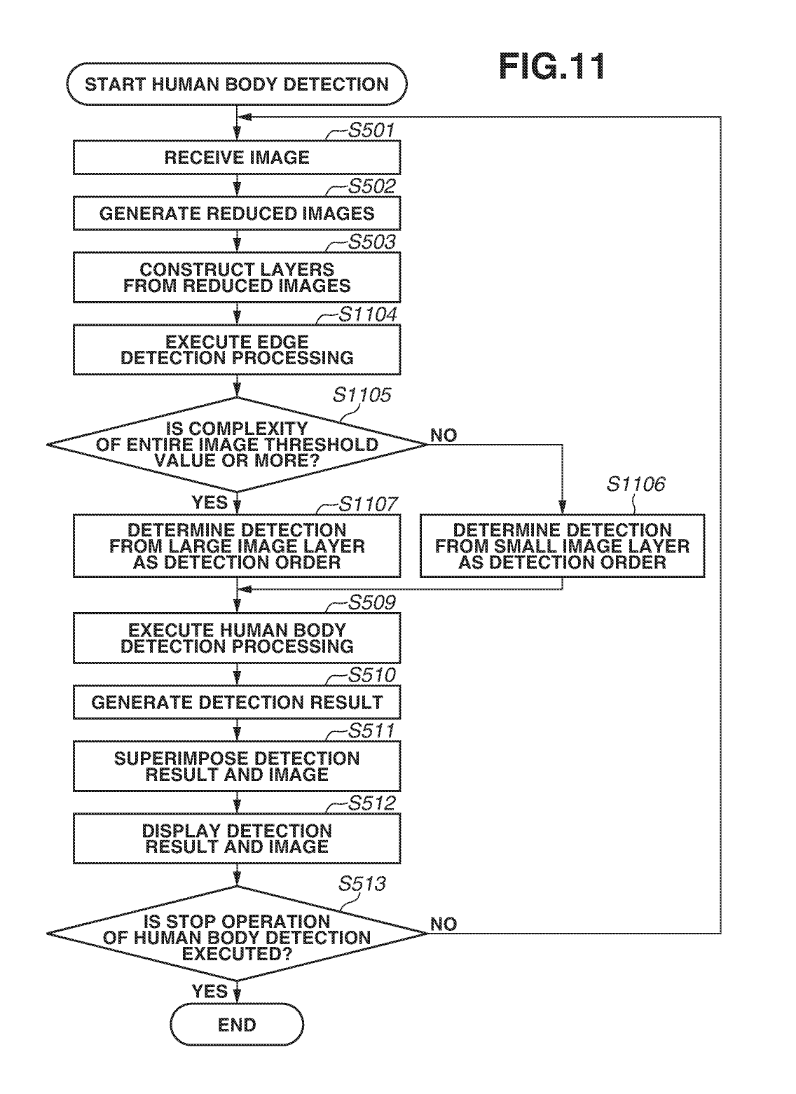

FIG. 11 is a flowchart illustrating an image processing method executed by the human body detection system 100 according to the present exemplary embodiment. The flowchart in FIG. 11 includes steps S1104 to S1107 in place of steps S504 to S508 of the flowchart in FIG. 5. Hereinafter, part of the present exemplary embodiment different from the first exemplary embodiment will be described.

First, in step S501, the image input unit 104 receives the image 210 from the image input apparatus 101. In step S502, the reduced image generation unit 105 recursively reduces the image 210 input from the image input unit 104 to generate the reduced images 204 to 209. In step S503, the layer construction unit 106 constructs the layer structure 201 from the input image 210 and the reduced images 204 to 209.

In step S1104, the complexity detection unit 1007 executes edge detection processing on the image 210 input from the image input unit 104 to detect complexity of the entire image 210. In step S1105, the layer determination unit 108 determines whether the complexity input from the complexity detection unit 1007 is a threshold value or more. If the layer determination unit 108 determines that the complexity is the threshold value or more (YES in step S1105), the processing proceeds to step S1107. If the layer determination unit 108 determines that the complexity is less than the threshold value (NO in step S1105), the processing proceeds to step S1106.

In step S1106, the layer determination unit 108 determines that human body detection should be performed in the order from a layer of a small image for detecting large human bodies to a layer of a large image. Then, the processing proceeds to step S509.

In step S1107, the layer determination unit 108 determines that human body detection should be performed in the order from a layer of a large image for detecting small human bodies to a layer of a small image. Then, the processing proceeds to step S509.

In step S509, the human body detection processing unit 110 executes human body detection processing of respective layers according to the detection order of layers determined by the layer determination unit 108. In step S510, the detection result generation unit 111 generates rectangle information of the human body based on the human body information input from the human body detection processing unit 110. In step S511, the image output unit 112 superimposes the rectangle information of the human body input from the detection result generation unit 111 on the image 210 input from the image input unit 104, and outputs the image with the superimposed rectangle information of the human body to the monitor apparatus 103. In step S512, the monitor apparatus 103 displays the image input from the image output unit 112. In step S513, the human body detection system 100 executes the processing similar to that of the first exemplary embodiment.

As described above, the human body detection processing unit 110 executes matching processing of the template image with respect to the plurality of images 204 to 210 in different orders according to the complexity of the image 210. If the complexity is the threshold value or more, the human body detection processing unit 110 executes matching processing of the template image with respect to the plurality of images 204 to 210 in the order from a large image to a small image as described in step S1107. Further, if the complexity is less than the threshold value, the human body detection processing unit 110 executes matching processing of the template image with respect to the plurality of images 204 to 210 in the order from a small image to a large image as described in step S1106. By changing the detection order of layers according to the complexity of the entire image 210, the human body detection system 100 can execute human body detection processing with high precision even in the environment in which the number of people is changed significantly.

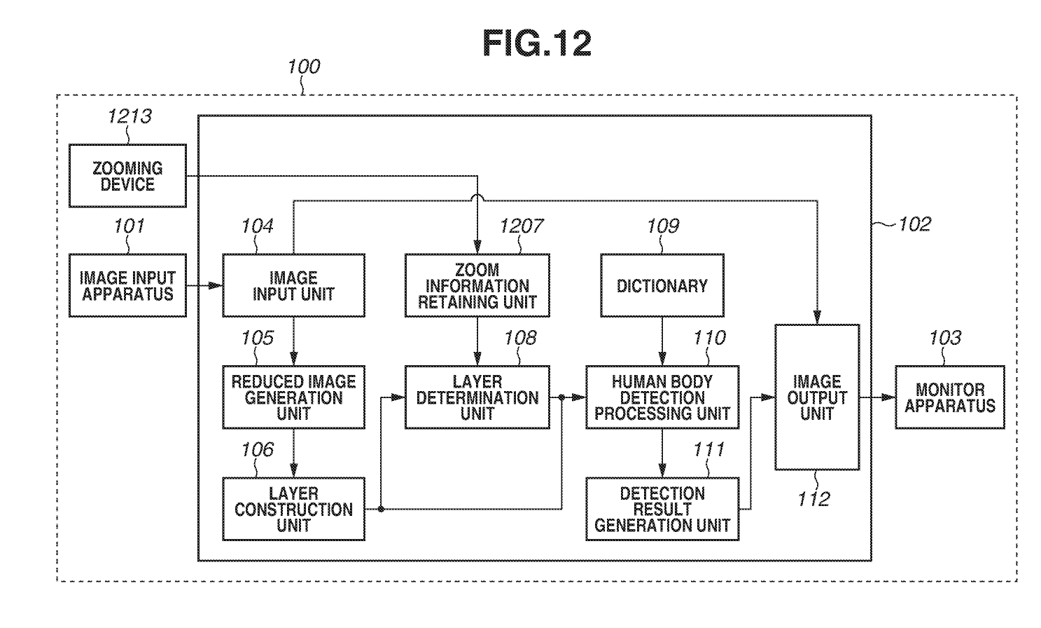

FIG. 12 is a block diagram illustrating a configuration example of a human body detection system 100 according to a fourth exemplary embodiment of the present disclosure. The human body detection system 100 in FIG. 12 additionally includes a zooming device 1213, and includes a zoom information retaining unit 1207 instead of the moving body detection unit 107 included in the human body detection system 100 in FIG. 1. The zoom information retaining unit 1207 is arranged in the human body detection apparatus 102. Hereinafter, part of the present exemplary embodiment different from the first exemplary embodiment will be described.

The zooming device 1213 includes a lens unit configured of a plurality of lenses, and adjusts a view angle of the image to be captured by moving a view angle adjustment lens included in the lens unit back and forth. The zooming device 1213 is configured of a plurality of lenses, a stepping motor for moving the lenses, and a motor driver for controlling a motor. The zooming device 1213 outputs zoom information to the zoom information retaining unit 1207.

The zoom information retaining unit 1207 retains the zoom information input from the zooming device 1213. The zoom information retaining unit 1207 outputs the retained zoom information to the layer determination unit 108.

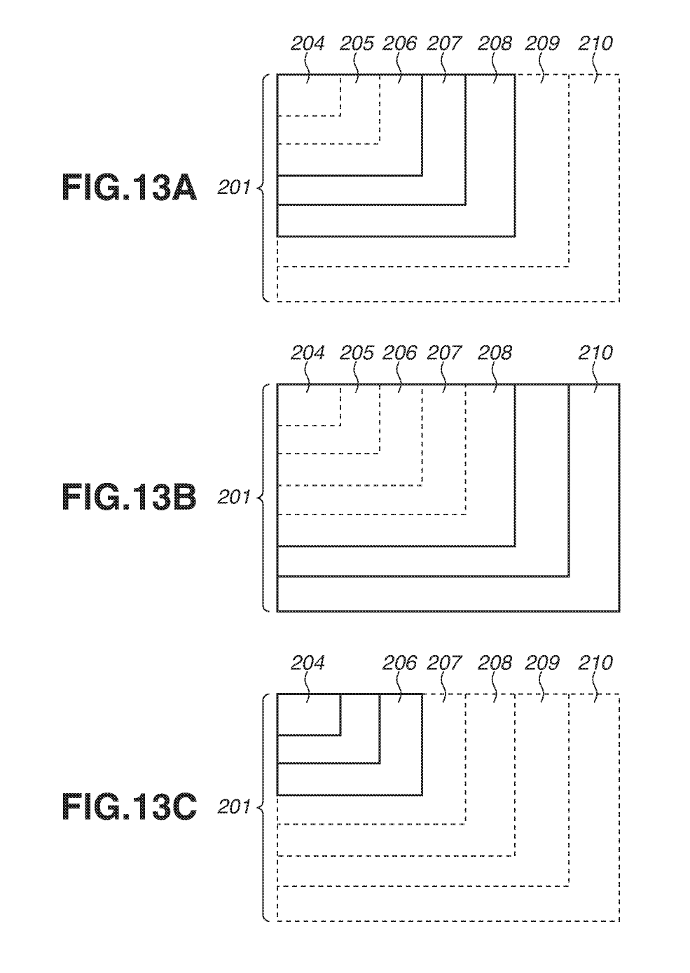

The layer determination unit 108 determines a layer detection starting position and a layer detection ending position based on the layer structure information input from the layer construction unit 106 and the zoom information input from the zoom information retaining unit 1207. Herein, processing of changing the layer detection starting position and the layer detection ending position will be described with reference to FIGS. 13A, 13B, and 13C.

When the zoom information is controlled in a zoom-out direction, the layer determination unit 108 controls the layer detection starting position and the layer detection ending position to be changed to the lower layers according to the zoom magnification so that the human body can be detected correctly even if the currently-detectable human body is zoomed out and reduced in size.

For example, as illustrated in the layer structure 201 in FIG. 13A, when the zoom magnification is 2-power, the layer determination unit 108 determines the detection starting position and the detection ending position as the layer 2 of the reduced image 206 and the layer 4 of the reduced image 208, respectively. When the zoom information is controlled in the zoom-out direction to cause the zoom magnification to be changed to 1-power, as illustrated in the layer structure 201 in FIG. 13B, the layer determination unit 108 changes the detection starting position and the detection ending position to the layer 4 of the reduced image 208 and the layer 6 of the original image 210, respectively. The detection processing is skipped with respect to the reduced images 204, 205, 206, and 207.

When the zoom information is controlled in a zoom-in direction, the layer determination unit 108 controls the layer detection starting position and the layer detection ending position to be changed to the upper layers so that the human body can be detected correctly even if the currently-detectable human body is zoomed in and increased in size.

When the zoom information is controlled in the zoom-in direction to cause the zoom magnification to be changed to 4-power, as illustrated in the layer structure 201 in FIG. 13C, the layer determination unit 108 changes the detection starting position and the detection ending position to the layer 0 of the reduced image 204 and the layer 2 of the reduced image 206 respectively. The detection processing is skipped with respect to the reduced images 207, 208, and 209, and the original image 210. Configurations other than the above-described configurations are similar to the configurations described in the first exemplary embodiment.

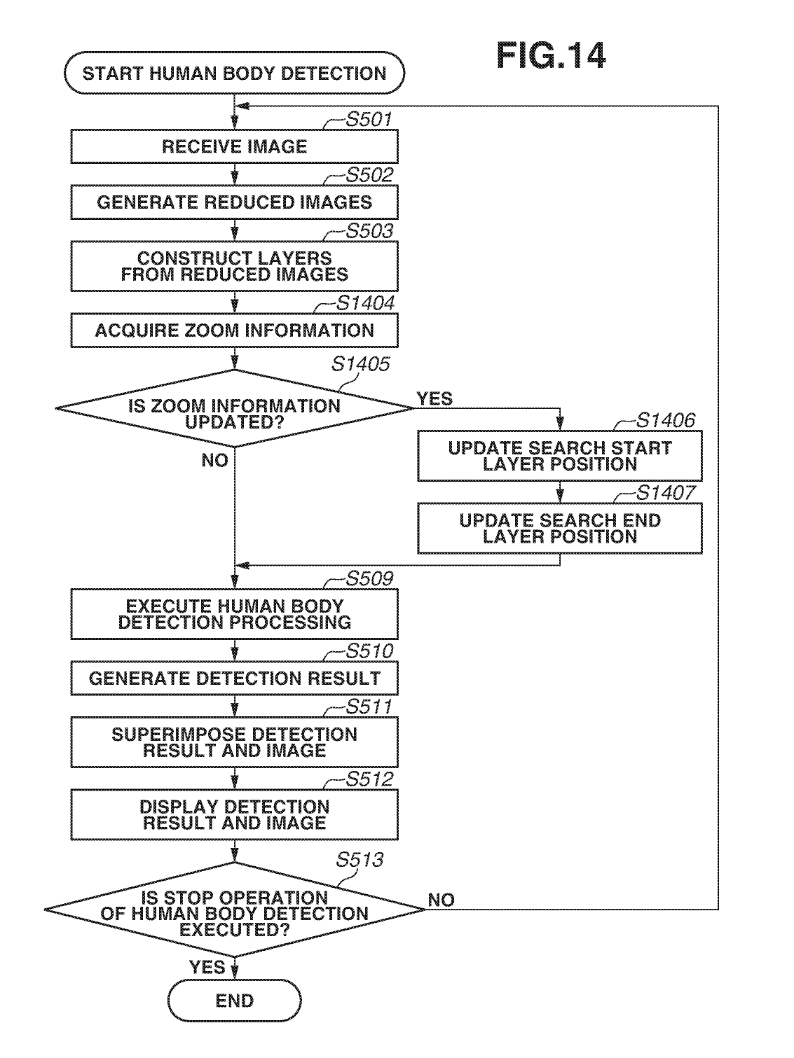

FIG. 14 is a flowchart illustrating an image processing method executed by the human body detection system 100 according to the present exemplary embodiment. The flowchart in FIG. 14 includes steps S1404 to S1407 in place of steps S504 to S508 of the flowchart in FIG. 5. Hereinafter, part of the present exemplary embodiment different from the first exemplary embodiment will be described.

First, in step S501, the image input unit 104 receives the image 210 from the image input apparatus 101. In step S502, the reduced image generation unit 105 recursively reduces the image 210 input from the image input unit 104 to generate the reduced images 204 to 209. In step S503, the layer construction unit 106 establishes the layer structure 201 from the input image 210 and the reduced images 204 to 209.

In step S1404, the zoom information retaining unit 1207 retains the zoom information input from the zooming device 1213. In step S1405, the layer determination unit 108 determines whether the zoom information input from the zoom information retaining unit 1207 is updated. If the layer determination unit 108 determines that the zoom information is updated (YES in step S1405), the processing proceeds to step S1406. If the layer determination unit 108 determines that the zoom information is not updated (NO in step S1405), the processing proceeds to step S509.

In step S1406, the layer determination unit 108 updates the search start layer position according to the zoom magnification. In step S1407, the layer determination unit 108 updates the search end layer position according to the zoom magnification.

In step S509, the human body detection processing unit 110 executes human body detection processing of respective layers according to the layer detection starting position and the layer detection ending position determined by the layer determination unit 108. In step S510, the detection result generation unit 111 generates rectangle information of the human body based on the human body information input from the human body detection processing unit 110. In step S511, the image output unit 112 superimposes the rectangle information of the human body input from the detection result generation unit 111 on the image 210 input from the image input unit 104 and outputs the image with the superimposed rectangle information of the human body to the monitor apparatus 103. In step S512, the monitor apparatus 103 displays the image input from the image output unit 112. In step S513, the human body detection system 100 executes processing similar to that of the first exemplary embodiment.

As described above, the human body detection processing unit 110 determines the layer detection starting position and the layer detection ending position according to the zoom magnification, and executes matching processing of the template image with respect to a part of the reduced images 204 to 209 to detect human bodies. In this way, even if control of changing the zoom magnification is executed, the human body detection system 100 can execute highly precise human body detection while preventing occurrence of disagreement in a detection result or false detection caused by zoom-in or zoom-out operation.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2017-173374, filed Sep. 8, 2017, and No. 2018-104554, filed May 31, 2018, which are hereby incorporated by reference herein in their entirety.

What is claimed is:

1. An image processing apparatus comprising:
an image generation unit configured to generate a plurality of images in different sizes by reducing an input image; and
a specific object detection unit configured to detect a specific object by executing matching processing of a template image with respect to a part of the plurality of images, or by executing matching processing of a template image with respect to the plurality of images in different orders according to the input image.

2. The image processing apparatus according to claim 1, further comprising a moving body detection unit configured to detect a moving body in the input image,
wherein the specific object detection unit executes matching processing of a template image with respect to a part of the plurality of images according to the moving body.

3. The image processing apparatus according to claim 2, wherein the specific object detection unit executes matching processing of a template image with respect to a part of the plurality of images according to a largest size and a smallest size of the moving bodies detected by the moving body detection unit.

4. The image processing apparatus according to claim 2, wherein the specific object detection unit executes matching processing of a template image with respect to a part of the plurality of images according to a congestion degree based on the moving bodies detected by the moving body detection unit.

5. The image processing apparatus according to claim 4, wherein the specific object detection unit executes matching processing of a template image with respect to all of the plurality of images in a case where the congestion degree is a threshold value or more, and executes matching processing of a template image with respect to a part of the plurality of images in a case where the congestion degree is less than the threshold value.

6. The image processing apparatus according to claim 1, further comprising a vanishing point detection unit configured to detect a vanishing point in the input image,
wherein the specific object detection unit executes matching processing of a template image with respect to the plurality of images in different orders according to a detection result of the vanishing point.

7. The image processing apparatus according to claim 6, wherein the specific object detection unit executes matching processing of a template image with respect to the plurality of images in an order of an image size in a case where the vanishing point is not detected, and executes matching processing of a template image with respect to the plurality of images in an order different from the order of an image size in a case where the vanishing point is detected.

8. The image processing apparatus according to claim 1, further comprising a complexity detection unit configured to detect complexity of the input image,
wherein the specific object detection unit executes matching processing of a template image with respect to the plurality of images in different orders according to the complexity.

9. The image processing apparatus according to claim 8, wherein the specific object detection unit executes matching processing of a template image with respect to the plurality of images in an order from a largest image to a smallest image in a case where the complexity is a threshold value or more, and executes matching processing of a template image with respect to the plurality of images in an order from the smallest image to the largest image in a case where the complexity is less than the threshold value.

10. The image processing apparatus according to claim 1, further comprising:
a zooming unit; and
a zoom information retaining unit configured to retain zoom information,
wherein the specific object detection unit executes matching processing of a template image with respect to a part of the plurality of images according to the zoom information.

11. The image processing apparatus according to claim 10, wherein the specific object detection unit executes matching processing of a template image with respect to an image of a lower layer of the plurality of images if the zoom information is changed to a zoom-out direction, and execute matching processing of a template image with respect to an image of an upper layer of the plurality of images if the zoom information is changed to a zoom-in direction.

12. The image processing apparatus according to claim 1, wherein the specific object is a human body.

13. An image processing method, comprising:
generating a plurality of images in different sizes by reducing an input image, by an image generation unit; and
detecting, by a specific object detection unit, a specific object by executing matching processing of a template image with respect to a part of the plurality of images, or by executing matching processing of a template image with respect to the plurality of images in a different order according to the input image.

14. A non-transitory computer-readable storage medium storing a program that causes a computer to execute the image processing method according to claim 13.
